(19) United States
(12) Patent Application Publication
(10) Pub. No.: US 2014/0162694 A1
(43) Pub. Date: Jun. 12, 2014

(54) SYSTEM AND METHOD FOR COMMUNICATING INFORMATION IN A LOCATION-BASED SYSTEM

(71) Applicants: Zachary Paul Maier, New York, NY (US); Adam Brett Poswolsky, Plainview, NY (US); Scott Snyder, San Francisco, CA (US); Nathaniel Keith Folkert, Brooklyn, NY (US)

(72) Inventors: Zachary Paul Maier, New York, NY (US); Adam Brett Poswolsky, Plainview, NY (US); Scott Snyder, San Francisco, CA (US); Nathaniel Keith Folkert, Brooklyn, NY (US)

(21) Appl. No.: 13/949,816

(22) Filed: Jul. 24, 2013

Related U.S. Application Data
(60) Provisional application No. 61/676,472, filed on Jul. 27, 2012.
(60) Provisional application No. 61/787,452, filed on Mar. 15, 2013.

(51) Int. Cl. H04W 4/04

(52) U.S. Cl. CPC H04W 4/04
USPC 455/456.3

(57) ABSTRACT

Systems and methods are provided that permit merchants, venue owners, and other entities defined within a location-based system to communicate with users. Additional communication capabilities are provided in a location-based service that permits merchants and other entities to engage users in different ways. One or more advertisers, merchants or other entities may be able to send messages to one or more users. For instance, if a user visits a venue more than a certain number of times in total, visits or “checks-in” to that venue over a period of time, indicates that the user follows or “likes” a particular venue or merchant, or performs some other activity with the location-based network, that merchant may be provided a vehicle for sending messages to those users. Targeted messages may be sent responsive to any information used in the location-based service, including active or passive user activity.

### RELATED APPLICATIONS

This application claims priority under 35 U.S.C. §119(e) to U.S. Provisional Patent Application Ser. No. 61/676,472, entitled “SYSTEM AND METHOD FOR COMMUNICATING INFORMATION IN A LOCATION-BASED SYSTEM,” filed on Jul. 27, 2012, of which application is herein incorporated by reference in its entirety. This application claims priority under 35 U.S.C. §119(e) to U.S. Provisional Patent Application Ser. No. 61/787,452, entitled “SYSTEM AND METHOD FOR COMMUNICATING INFORMATION IN A LOCATION-BASED SYSTEM,” filed on Mar. 15, 2013, of which application is herein incorporated by reference in its entirety.

### BACKGROUND

There are many location-based systems in use today. In particular, location-based services such as the Foursquare system (available on the Internet at http://www.foursquare.com) permit users to verify their locations using one or more computer systems. Some services permit users to use their locations for the purpose of interacting within a social network. For instance, within one type of location-based social network, users are permitted to perform a “check-in” to particular locations, including venues such as businesses, retail locations, points of interest, or other locations. A check-in generally includes a process that identifies a user with a particular venue location at a given time, and such check-ins may be recorded over time (e.g., by a location-based social network). Such location-based social networks also permit users to interact with friends, find venues of interest, leave comments regarding particular venues, among other functions.

### SUMMARY

According to some aspects of the present invention, systems and methods are provided that permit merchants, venue owners, and other entities defined within a location-based system to communicate with users. For instance, within traditional location-based networks, users “check-in” to venues and are permitted to search for venues, specials, and other information. However, it would be useful to have additional communication capabilities that permit merchants and other entities to engage users in different ways.

In one embodiment, one or more advertisers, merchants or other entities may be able to send messages to one or more users. For instance, if a user visits a venue more than a certain number of times in total, visits or “checks-in” to that venue over a period of time, indicates that the user follows or “likes” a particular venue or merchant, or performs some other activity with the location-based network, that merchant may be provided a vehicle for sending messages to those users. For instance, it may be beneficial to offer promotions, send advertising messages, or otherwise engage users based on their activity in a location-based system.

To this end, a system may be provided that permits advertisers and other providers to create messages that are delivered to a user based on their activity with a location-based system. In one embodiment, a user may be indicated as one that receives certain types of messages when that user interacts with a particular venue location and/or merchant. For instance, if that user has checked in to a particular venue X number of times, an indication may be set in the location-based system that permits the venue location owner to target messages to that user. In another example, messages may be sent to a user that merely has an association with the merchant.

In one embodiment, it is appreciated that a user may interact with many venues, all capable of targeting messages to the user. Therefore, according to one embodiment, it may be beneficial to enable the messages to be delivered to the user selectively based upon the user's location. So, for instance, if the user is located in San Francisco, but “likes” a coffee shop in Seattle, the user will not be targeted for any communications while the user is not located near the coffee shop in Seattle. In one example, if the user is located within a particular city, town, or other defined area (e.g., a state serviced by the merchant), then the user may be targeted for particular messages from a particular merchant if the user has made the defined activity level with that venue or merchant.

According to one embodiment, the messaging does not require the permission to opt-in or otherwise authorize the communication of messages, but rather the user's activity with the merchant or venue within the location-based system that causes the messaging to occur. Having the capability to target users based on location (e.g., What users are located near my venue?) allows merchants to more access, in a more focused manner, the users that are capable of performing purchases.

In another embodiment, the user need not be located within a particular region to receive messages from a merchant. Rather, the user may be sent any message type by the merchant if that user achieved the particular status or activity level within the location-based system. For instance, if the user checks in to a particular venue location a prescribed number of times, that user can receive messages from the merchant.

According to one embodiment, a location-based system may use one or more signals to determine the strength of a relationship between two or more entities to determine whether a communication should occur between those entities. For instance, the location-based system may observer behavior of the user (e.g., over a period of time), and when the user has achieved a certain level of contact with a venue, a communication path may be established between the user and the venue is established by the location-based system. Thus, according to one aspect, strength of location-based system signals may be used to determine the probability of a message. This functionality contrasts with typical opt-in users that require a single action to opt-in by the users themselves (e.g., a “Follow” on Twitter) in that the connection is performed by the location-based system, and the connection may be based on a group of activities and not a single user-defined action.

In one embodiment, a number of different capabilities may be provided to a merchant to selectively communicate messages. For instance, in the case of multiple stores or a chain, a capability may be provided to selectively target a group of users associated with specific stores, groups of stores with a region, or an entire chain of stores (or other venue type). For example, with a chain of venues (e.g., stores), capability may be provided to allow the merchant to send updates regarding all venues in the chain or an arbitrary subset of venues within the chain.

In another example implementation according to various embodiments, user capability (e.g., to a merchant) may be provided that allows for delegated management at venues within a chain. In an example case, someone at National Coffee's corporate headquarters manages all the venues in the National Coffee chain, and therefore, can send messages to customers near any of those venues in the National Coffee chain. According to one embodiment, delegated management capability is provided that permits a manager to delegate access to other people (e.g., submanagers) who manage individual venues (or an arbitrary set of venues). These submanagers, who only manage a subset of the National Coffee venues, are permitted only to send updates to customers near the specific venues they manage. This means that the manager of National Coffee at 6th and 14^{th} could send updates as National Coffee to any customers of national coffee, so long as they are currently located near the 6th and 14th venue. One additional benefit is that those customers may be patrons of another National Coffee and may have never visited the branch at 6th and 14th, but this manager can reach the customers directly since the users are located near his/her specific venue.

In another embodiment, capabilities are provide to engage users that are online, mobile, or in the venue location. For instance, when just online, users may be provided a control that associates them with the venue or merchant (e.g., a “like” control or other control type that associates a venue, product, manufacturer or content with the user). When mobile, certain venues or merchants may be saved for later access. When at or near the venue location, the user can “check-in” to the venue within a location-based application. Thus, conversion and/or targeting of users at different points is a useful capability to increase conversions.

Aspects of the present invention relate generally to advertising and specials. In one aspect, a location-based system may be provided that allows users to locate one or more venues based on location, as well as other information (e.g., recommendations by others, where people having similar tastes have been, what is popular, etc.). In one embodiment, such advertising and/or specials may be displayed to a user operating a mobile device, such as a cell phone. The mobile device may request (e.g., from a server), a list of recommendations in one or more categories based on the device's location.

Further, a facility may be provided for merchants, venue owners, and other entities to broadcast messages to particular users. For instance, based on a location of a user within the location-based system, the user may be sent one or more broadcast messages. For example, in one implementation, a user having a device within a certain distance radius of a venue may be targeted for a particular broadcast message. Such messages may include general communications, advertisements, specials, offers, or other information capable of being communicated through a location-based network. Such messages may be communicated in a mobile application, such as a location-based service application. In some instances, merchants may want to proactively communicate with users when the user has not opened the mobile application. According to one embodiment, the location-based service executes a background process that provides messaging functions when the application is not operating. In such a case, a user may be alerted of a message in an interface (e.g., of a mobile phone) when the user enters a geographic area with which a message is associated.

According to one embodiment, information associated with the user is used to determine whether a message is targeted to the user. In one example, venue locations where the user has previously visited may influence what messages may be sent to that user. For instance, a location-based service may store information for each particular user, including preference information identifying preferences of particular venues the user has visited (e.g., “tips”). Further, the location-based service may store preferences for venues that the user has not yet visited (e.g., “to do” information).

In another embodiment, information associated with other users in the location-based system may be used to determine whether a message is targeted to the user. For instance, for users that are the current users “friends,” information regarding what venues those users have visited, their preferences for particular venues, and preferences for venues that they have not visited may be used to influence what messages may be displayed to the current user. Other users not in the current user's network may also be used to determine what messages are displayed. For instance, particular messages may be determined as more popular and/or have higher quality ratings as determined by other users, specific groups of users, or the entire network itself.

As discussed, tools may be provided to merchants to communicate messages to users of the location-based service. Further, additional tools may be provided to promote items within the location-based service. Such items may be displayed more prominently within lists (e.g., of recommendations), appear within certain areas of a location-based service application interface (e.g., near a top portion of the interface), be displayed as notifications both within the application and as a notification when the application is not active, and be displayed responsive to certain user actions (e.g., after a check-in, opening the application, performing a search, etc.), among other display methods. Items that can be “promoted” include venues, advertisements, specials, offers, messages as discussed above, or any other item within the location-based service.

According to one embodiment, a search engine associated with a location-based service may provide information based on one or more inputs provided by a user (e.g., via an interface of a mobile device). For instance, a user may be located at a particular location and that user decides he/she would like to purchase food. That user may also provide more specific information (e.g., the keyword “that”) although the user could be less specific and just specify a category such as “food.” In one implementation, the user may select a control on the mobile device (e.g., a button) that specifies the category “food” or lists a number of categories of interest (e.g., in a menu structure). In the example above, the user may not want to travel past a certain distance, so the interface may permit the user to enter a distance limitation to the search along with the user's current location. The search engine may use any parameters provided by the user and the system (e.g., location of the user in latitude/longitude, altitude, etc.) to determine a list of venues to recommend to a user. Further, based on these user inputs, searches, venue choices or other activities within the location-based service, one or more messages may be displayed to the user.

According to another aspect of the present invention, a location-based system may use an adjustable boundary of a geographical area in which to trigger a display of messages to a particular user responsive to an action performed by a user in a location-based service. In one embodiment, the geographic area may be determined by a user (e.g., located within 1 mile of a particular venue, within the San Francisco area, within 200 feet of any store of the chain, etc.). According to one embodiment, the boundary of search may be adjusted based on the density of venues within a particular area. For instance, from a particular geographic point, a radius from the geographic point may be adjusted to achieve a particular venue density within a circular area. The boundary can be adjusted based on other criteria, such as a determination of how far other users have tended to travel from the point the current user is located when the a query was made. Although a circle may be used as a boundary, other boundary types and shapes may be used (e.g., square, rectangle, displayed map area, town, or similar boundary).

According to one aspect, a method for presenting information to a user by a location-based system is provided. The method comprises acts of creating, by a merchant associated with a venue, a message to be communicated to one or more users in the location-based system; storing the message in the location-based system, determining user activity associated with a user in the location-based system, and determining, based on the user activity in the location-based system, whether the message should be communicated to the user; and if so, communicating the message to the user.

In one embodiment, the user activity includes at least one of a group of user activities comprising a check-in to the venue; a “like” of the venue; travel by the user to a location within a distance or area of the venue; and an action performed by the user in a location-based system. In one embodiment, the act of determining whether the message should be communicated to the user further comprises an act of determining if the user provided an indication that the user would like to receive messages from the venue. In one embodiment, the act of determining whether the message should be communicated to the user further comprises an act of determining whether the user has checked into the venue a predetermined number of times. In one embodiment, the act of determining whether the message should be communicated to the user further comprises an act of determining whether the user has achieved a defined level of activity with the venue. In one embodiment, the act of determining whether the message should be communicated to the user further comprises an act of determining whether the user has performed a group of sufficient activities within the location-based network. In one embodiment, the method further comprises an act of providing for a merchant to delegate management and creation of message functions to one or more entities. In one embodiment, the merchant is permitted to delegate management and creation of messages based on a location of a venue. In one embodiment, the merchant is permitted to specify a time of delivery in association with communicating the message to the user.

In one embodiment, the method further comprises acts of determining a location of the user, and determining, at least in part based on the determined location of the user, whether the message should be communicated to the user. In one embodiment, the method further comprises acts of determining a predefined location in which the message should be delivered, and determining whether the user is located within the predefined location. In one embodiment, the act of determining a predefined location includes an act of predefining, by the merchant, an area in which the message should be delivered, and the method further comprises an act of determining whether the user is located within the predefined area. In one embodiment, the method further comprises acts of determining a predefined location in which the message should be delivered, and determining whether the user is located near the predefined location. In one embodiment, the act of predefining an area in which the message should be delivered includes at least one of a group comprising defining a locale; defining a location and radius around the location; defining latitude and longitudinal limits; and defining a geographical area. In one embodiment, the method further comprises an act of permitting a submanager to define and send one or more messages associated with a venue of a chain that the submanager is permitted to manage. In one embodiment, the method further comprises an act of permitting a manager to selectively create and send messages to one or more venues of a chain of venues. In one embodiment, the method further comprises an act of restricting access to a submanager to perform management functions to one or more venues of a chain that the submanager is permitted to manage.

According to one aspect, a method for processing venue information in a location-based system is provided. The method comprises acts of receiving a message to be communicated to one or more users in the location-based system; storing the message in the location-based system; determining user activity in the location-based system; determining, based on the user activity in the location-based system, whether the message should be communicated to the user; and if so, communicating the message to the user. In one embodiment, the method further comprises acts of determining a location of the user, and determining, at least in part based on the determined location of the user, whether the message should be communicated to the user.

According to one aspect, a location-based system for presenting information to a user is provided. The system comprises a component that permits creation, by a merchant associated with a venue, a message to be communicated to one or more users in the location-based system; a memory adapted to store the created message; a component adapted to determine user activity associated with a user in the location-based system; a component adapted to determine, based on the user activity in the location-based system, whether the message should be communicated to the user; and a component that communicates the message to the user, if it is determined by the component adapted to determine, based on the user activity in the location-based system, whether the message should be communicated to the user that the message should be communicated. In one embodiment, the user activity includes at least one of a group of user activities comprising a check-in to the venue; a “like” of the venue; travel by the user to a location within a distance or area of the venue; and an action performed by the user in a location-based system.

In another embodiment, the system further comprises a component adapted to determine if the user provided an indication that the user would like to receive messages from the venue. In another embodiment, the component is adapted to determine, based on the user activity in the location-based system, whether the message should be communicated to the user is responsive to a component that determines whether the user has checked into the venue a predetermined number of times. In another embodiment, the component is adapted to determine, based on the user activity in the location-based system, whether the message should be communicated to the user is responsive to a component that determines whether the user has achieved a defined level of activity with the venue. In one embodiment, the component adapted to determine, based on the user activity in the location-based system, whether the message should be communicated to the user is responsive to a component that determines whether the user has performed a group of sufficient activities within the location-based network. In one embodiment, the system further comprises an interface that permits merchant to delegate management and creation of message functions to one or more entities. In one embodiment, the interface permits the merchant to delegate management and creation of messages based on a location of a venue. In one embodiment, the system further comprises an interface that permits the merchant to specify a time of delivery in association with communicating the message to the user.

In one embodiment, the system further comprises a component adapted to determine a location of the user, and a component adapted to determine, at least in part based on the determined location of the user, whether the message should be communicated to the user. In one embodiment, the system further comprises a component adapted to determine a predefined location in which the message should be delivered, and a component adapted to determine whether the user is located within the predefined location. In one embodiment, component adapted to determine a predefined location includes a component that accepts information from the merchant that defines an area in which the message should be delivered, and wherein the system further comprises a component adapted to determine whether the user is located within the predefined area. In one embodiment, the system further comprises a component adapted to determine a predefined location in which the message should be delivered, and a component adapted to determine whether the user is located near the predefined location. In one embodiment, the information received from the merchant that defines an area in which the message should be delivered includes at least one of a group comprises a locale; a location and radius around the location; latitude and longitudinal limits; and a geographical area. In one embodiment, the system further comprises an interface that permits a submanager to define and send one or more messages associated with a venue of a chain that the submanager is permitted to manage. In one embodiment, the system further comprises an interface that permits a manager to selectively create and send messages to one or more venues of a chain of venues. In one embodiment, the system further comprises an interface that restricts access to a submanager to perform management functions to one or more venues of a chain that the submanager is permitted to manage.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one example are discussed below with reference to the accompanying figures, which are not intended to be drawn to scale. The figures are included to provide an illustration and a further understanding of the various aspects and examples, and are incorporated in and constitute a part of this specification, but are not intended as a definition of the limits of a particular example. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1 is a block diagram showing a location-based service and system suitable for incorporating various aspects of the present invention;

FIG. 2 shows a block diagram of a distributed system suitable for performing various aspects of the present invention;

FIGS. 3A-3B are block diagrams showing example processes for targeting messages from a merchant in a system that uses location-based services;

FIG. 4A shows a block diagram of location-based service entities according to one embodiment of the present invention;

FIGS. 4B-4E show example interfaces associated with messages that may be communicated in a location-based service according to one embodiment of the present invention;

FIGS. 5A-5E show example management relationships in a location-based service database according to one embodiment of the present invention;

FIG. 6 shows an example management interface according to one embodiment of the present invention;

FIG. 7 shows example management relationships and view behaviors according to various embodiments of the present invention;

FIG. 8 shows another example of management relationships and view behaviors according to various embodiments of the present invention;

FIG. 9 shows another example of management relationships and view behaviors according to various embodiments of the present invention;

FIG. 10 shows an example interface according to the embodiment of the present invention;

FIG. 11 shows another example interface according to another embodiment of the present invention;

FIG. 12 shows an example computer system with which various aspects of the invention may be practiced; and

FIG. 13 shows an example storage system capable of implementing various aspects of the present invention.

### DETAILED DESCRIPTION

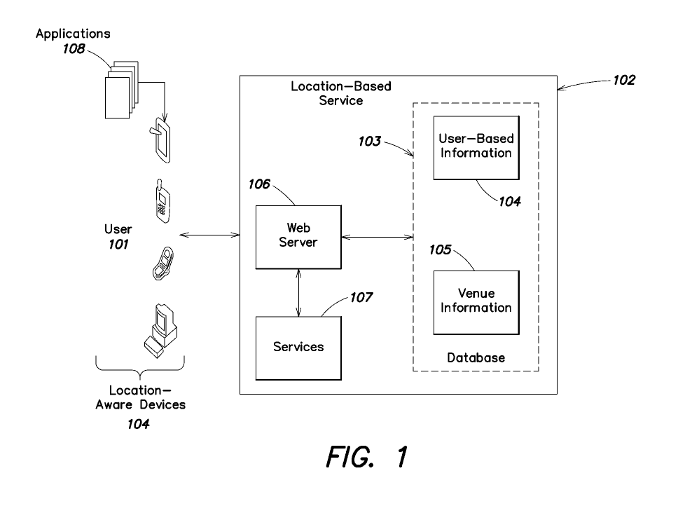

FIG. 1 shows a block diagram of a location-based service and system suitable for incorporating various aspects of the present invention. For instance, a location-based service 102 may permit one or more users (e.g., user 101) to interact with one or more other users, systems and services based on their location. To this end, the user's location may be determined using one or more location-aware devices (e.g., devices 104), such as, for example, a cell phone, smart phone, PDA, tablet computer, laptop or other system, The location-based service may provide one or more recommendations for the user based on their location. Further, as discussed above, the location-based service may also provide the ability for merchants to target users based upon their activities within the location-based service.

Users may use an interface of the location-aware device for interacting with the system to receive recommendations and other information relating to certain venue locations. This information may be provided responsive to one or more inputs a user might provide within the interface of the mobile device, such as a query formed by one or more keywords, selection of particular search categories (e.g., “Food”, “Nightlife”, etc.), distance from the user's current location, or other parameters, either alone or in any combination. In one embodiment, a merchant or other user type may be provided the capability of messaging location-based service users responsive to certain criteria.

In one embodiment, service 102 may include one or more components. Such components may be implemented using one or more computer systems. In one embodiment, location based service 102 may be implemented on a distributed computer system using one or more communication networks (e.g., the Internet). In one implementation, the service is implemented in a cloud-based computing platform, such as the well-known EC2 platform available commercially from Amazon.com, Seattle, Wash. Other implementations are possible and are within the scope and spirit of the invention, and it is appreciated that other platforms may be used.

Service 102 may include a web server 106 which is capable of serving as a front end to the location-based service 102. Devices may communicate and display data provided by service 106 to the user (e.g., user 101). Notably, devices may include controls that perform various functions in a location-based application (such as one or more of application(s) 108), such as viewing venues proximate to the user's location, reviewing information regarding proximate venues left by other users, communicating with other users, among other functions. Further, such devices may provide the location of the user to the location-based service 102, and this location information may be used to perform one or more functions.

Service 102 may also provide one or more related services (e.g., services 107), such as a service for recommending venues, storing pictures based on location, location-based games, or other service that utilizes location information relating to its users. Services 107 may be integral to location-based service 102 or many alternatively operate in conjunction with location-based service 102, (e.g., by communicating with the location-based service through an Application Programming Interface (API)). Notably, according to one aspect of the present invention, recommendations for particular venue locations defined within service 102 may be provided to a user.

Service 102 may also be capable of storing information in one or more databases (e.g., database 103). For instance, service 102 may be configured to store user-based information (e.g., user-based information 104) such as a user identification, identifications of friends associated with the user identification, any history information such as locations visited, preference information for particular venue locations, notes regarding venue locations visited, among other user-related information. Service 102 may also be capable of storing venue information (e.g., venue information 105) that may include, for example, location information (e.g., address, latitude, longitude, altitude, etc.), contact information, venue description, among other information. Venue information may also include, according to one embodiment, preference information for the particular venue.

One commercially-available system that may be suitable for implementing various aspects of the present invention may include the Foursquare service, available at http://www.foursquare.com and provided by Foursquare Labs, Inc., New York. Other systems capable of providing location-based services are available and are capable of implementing various aspects of the present invention.

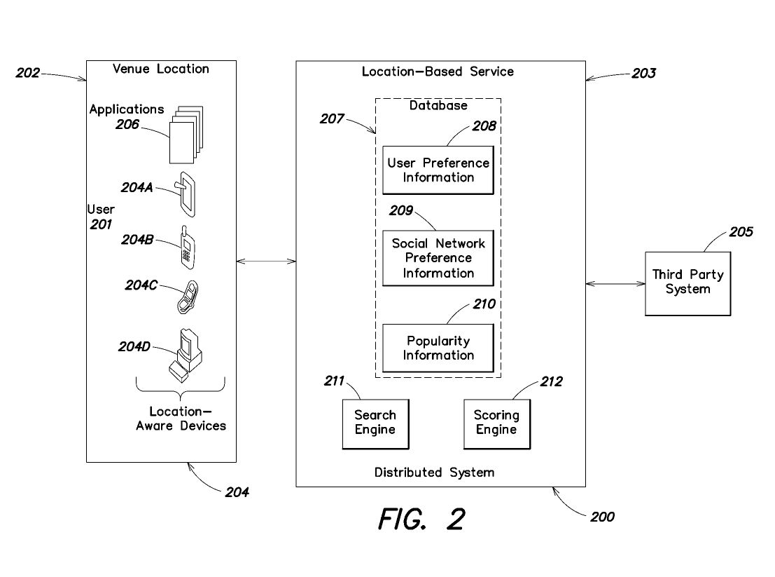

FIG. 2 shows a system incorporating various aspects of the present invention. In particular, a distributed computer system (e.g., system 200) may be provided that is capable of providing a facility for messaging between merchants and venue owners in association with a location-based system (e.g., system 203). Such messages may be provided to one or more users (e.g., through an interface of a user-facing application of a mobile device). Further, such messages may be provided to other systems and/or applications that work integrally with location-based service 203. For instance, a third party system (e.g., system 205) may be capable of receiving messages for one or more venue locations from the location-based system.

Such messages may be presented to users (e.g., user 201) at or near one or more venue locations (e.g., venue location 202) on one or more location-aware devices (e.g., device 204). For instance, messages may be presented and viewed using one or more applications 206 that execute on a location-aware device. Device 204 may be any device, system, or item that can be used to locate a user, including a tablet computer (element 204A), smartphone (element 204B), cell phone (204C), personal computer (element 204D), or other system type.

Location-based service 203 may include, for example, a search engine 211 that receives search information from one or more applications 206, and provides messages to a location-aware device for display to the user. Search engine 211 may be capable of accepting one or more parameters such as keywords, distance settings, among others, from the location-aware device and provide a list of venues that satisfy the provided parameters. Search engine 211 or any other separate process or element may be capable of ordering and/or ranking the search results based on one or more sets of information stored in a database of the location-based service.

For instance, a database 207 may be provided (either separate or the same as database 203) that stores user preference information (e.g., information 208) relating to venues stored by the location-based service. Such information may include, for example, a history of venues the user has previously visited and their rating of such venues. User preference information may also include preference information for venues that the user has not yet visited. Database 207 may also store social network preference information (e.g., information 209) relating to venues stored by the location-based service. For instance, for users defined within the location-based service or are defined in other social networking applications that are indicated as the current users “friends,” information regarding what venues those users have visited, their preferences for particular venues, and preferences for venues that they have not visited may be used to influence what targeted messages may be displayed to the current user. Targeted messages may be sent responsive to any information used in the location-based service, including activity of the user, both active and passive. User activity may include, for example, selecting, searching, viewing or navigating in a location-based service application, checking-in at a venue, operating a mobile device within a particular geographic location, operating a “radar” application that shows venues with a range of the user's location, etc. Further, targeted messages may be sent to a user based on activity of other users (e.g., a friend “liked” a particular message). Also, targeted messages may be sent based on only location (e.g., target users currently located in San Francisco). Further, users may be targeted based on any other information (e.g., targeting users located in particular areas, or targeting users that meet any other location-based criteria). It should be appreciated that targeted messages may be sent responsive to any activity or information of the location-based service, either alone or in combination with any activity or information.

Database 207 may also store one or more messages associated with the location-based service. For instance, according to one embodiment, the location-based system may include, a targeted message created within the system. The targeted message, when matched to a particular query or criteria related to a location-based user, triggered as a result of the users' location or action within the location-based service application, or as a result of other display criteria, may cause the message to be displayed within the interface of the location-based service application. The interface may display any information relating to the location-based message, including, but not limited to text-based messages, photo(s), special or other offer information, or any combination of information.

Further, database 207 may store popularity information (e.g., information 210) relating to venues defined in the location-based service. For instance, other users not within the current user's social network may also be used to determine what recommendations are displayed. For instance, certain venues may be determined as more popular and/or have higher quality ratings as determined by other users, specific groups of users, or the entire network itself.

In one embodiment, the user “checks-in” to the location-based service using an application executing on the mobile device, and responsive to the user “checking-in,” that user is permitted to receive messages within the location-based service from a particular venue. Such messages may be delivered to the user at or near a location of the venue where the user “checked in” or where the user is otherwise located. For example, as discussed above, a user's location may be determined by a location-aware device. In certain embodiments, the user may be permitted to check in using a number of different applications (e.g., Check-in4Me, 4squareSMS, Foursquare, etc.) into the same location-based service or from another location-based service that shares location and check-in information regarding users. In one implementation, application providers may be permitted to receive messages from the location-based service for display to their users. Some applications that do not provide check-in services may still be capable of receiving messaging information from the location-based service.

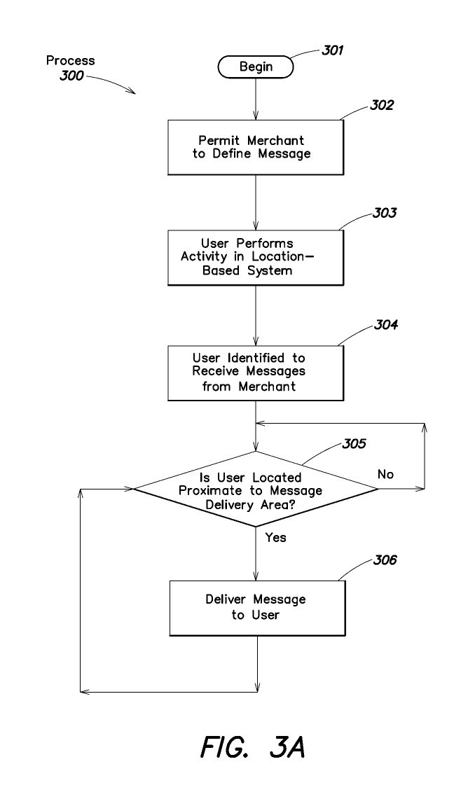

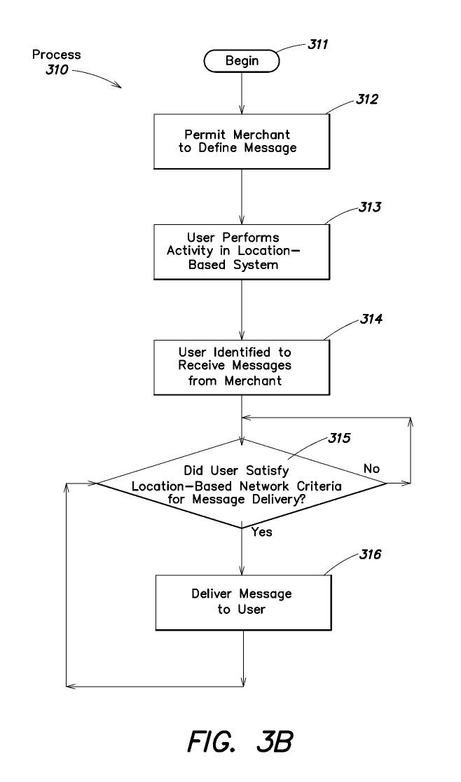

FIG. 3 shows an example process 300 for providing messaging capability to a user according to one embodiment of the present invention. At block 301, process 300 begins. At block 302, the system permits a merchant or other entity to define a message. This message may have one or more parameters, including information to be communicated to a user. The message may also have images, text, photos, information provided by other users regarding the venue, among other information. At block 303, the user performs an activity within the location-based system. For instance, the user may check in to a venue, operate a location-based application that identifies the user to be located at a particular place or within a region, “liked” or followed a particular venue or chain, operating a map window that shows venues on the map, or any combination of activity may be used to determine when a user is identified to receive messages from the merchant (or venue) at block 304. It should be appreciated that messages may be sent responsive to any information used in the location-based service, including user activity such as, for example, selecting, searching, viewing or navigating in a location-based service application, checking-in at a venue, operating a mobile device within a particular geographic location, etc.

At block 305, it is determined whether the user is proximate or close to to the message delivery area. For instance, the merchant may be permitted to target particular geographical areas (e.g., within a range of the venue, within a particular area, city, state, or other geographical construct, etc.) to which messages are directed. If the user is located at the particular location (or within an area), the location-based system delivers the message to the user at block 306. For instance, the message may be presented to the user within a display of the location-based service application. If the application is not currently active, a background process (e.g., executing on a mobile device) may send a notification to the user responsive to the user being located at the location or within a designated area (e.g., a push notification).

In an embodiment where the merchant may be permitted to send messages not based on location, such messages may be sent at certain times or during certain periods as defined by the merchant. In such a case, users may be targeted for messages based on their activity within the location-based network. Process 300 may continue indefinitely as the location-based system is executed, and the merchant(s) or other entity(ies) may be permitted to create messages and have them delivered to one or more users. In another embodiment, users may be provided controls that allow them to control which merchants/venues may send messages.

In another embodiment, social networking systems may also be leveraged to find associations with merchants/venues, or otherwise communicate with users (e.g., messages may be propagated to one or more social networks with which the user is associated). In one embodiment, a social networking platform may be integrated with a location-based system, and one or more associations between location-based entities may be shared between the social network and location-based network. In one implementation, controls may be provided that permit relationship information relating users and other entities such as venues, manufacturers, and other entities to be shared among systems.

Merchants may be permitted to send broadcasts based on one or more criteria, either alone or in combination with other criteria. For instance, a relationship between the user and the merchant or venue may determine whether a particular user receives a message from the merchant or venue (or other location-based service item). For instance, in one implementation, a user's direct engagement with received messages may determine whether that user receives additional messages. For instance, if a user “likes” or comments on a message, selects the “like” or comment, the location-based service may record that action and will show future messages from the merchant, venue, or other location-based service item because the user performed an action relative to that merchant, venue, or item.

Merchants may also be able to determine a geofence within which users that have relationships to the merchant, venue, or item will receive messages. For instance, a merchant may define a point and radius distance within which the user will receive messages, an address, latitude/longitude or other location-based criteria that specifies an area in which the user can receive messages. Further, the merchant may be permitted to set triggers that define the conditions under which a user will receive a message. For instance, a merchant or location-based entity may define a trigger that determines the closeness of the user to a designated location in which the merchant is messaging about. In another example, a trigger may be defined based on a closeness of the user to a location that the message is being generated. In yet another example, a trigger may be defined based on a closeness of a user to any location within a chain of merchant locations.

Further, users may be able to “opt-in” to receiving different messages from venues or locations that the user is interested in viewing. For instance, a user may selectively opt-in to certain venues, groups of venues, or other items or geographical areas that the user is interested in receiving. For instance, the user may opt-in to receive messages from a favorite coffee place in New York, even though the user is located in San Francisco for the week.

Further, a user's engagement over time may affect whether the user receives messages from the location-based service. For instance, a time-weighted measurement of the user's checkin history (e.g., weighted more heavily toward recent checkins) may be used to determine if the user receives updates from a particular venue. In another implementation, a rolling average (e.g., three month rolling average) may be used to avoid receiving messages from venues the user no longer frequents. Other time or frequency-based approaches may be used, such as by determining how often a user selects the venue within the location-based application, how often the user views a venue web page or application page related to the venue, or other number of other actions the user performs with the location-based item.

In another embodiment, a user's social connections may determine whether the user receives messages from the merchant, venue or item. For instance, if a friend is engaged with the merchant, venue or item, the user may be sent messages by the location-based service. Also, how frequently a user's friends check-in to the venue may be used by the location-based service to determine if the user receives messages from the merchant, venue or item. Also, if a user's friends “like” a particular venue or comment on the venue, commented on messages sent, or “like” particular messages, the location-based service may opt-in a user for receiving messages from the merchant, venue or item.

Further, the merchant, venue, item, and/or related messages' popularity may determine whether a user may receive currently defined or future messages. For instance, if a current message has 50,000 likes and the user has a weak association with the venue, the location-based service may direct the message to the user. Other signals may be used to determine whether messaging is performed, such as determining on how many lists the venue appears, how many of the user's friends liked the venue or have checked in to the venue, etc.

Further, in another implementation, a user may be permitted to send a message to his/her network regarding the message. For example, a venue may be having a special that the user would like to broadcast to their friends that are located in his/her neighborhood. A facility may be provided within the location-based service for users to communicate messages locally to other users in their social network.

In general, a facility if provided to the merchant, venue or other user to create a message in a location-based system that is delivered to users selectively at different points in time based on their activities with the location-based network. This contrasts to general messaging facilities (e.g., email, texts, etc.) where messages are sent as soon as they are defined to specific users or specific groups of users. Rather, merchants, venue operator or other user types may define a message with different triggering parameters, and users receive that message when the conditions are triggered. If done appropriately, messages are more accurately targeted to users that are in the best position to act on the messages, the messages are of the type in which the user is interested and the user is less apt to ignore them, or the messages are “opted-in” by the user and the user will receive the messages as long as they would like to receive them. One parameter includes the user's location in relation to a defined location by the merchant. For example, the merchant may define (e.g., within a management interface) a location that, when the user enters or is located within a certain distance of, triggers a condition that would cause a message to be sent or otherwise displayed to the user within a location-based service application. This capability is particular useful for merchants or venue owners that wish to create messages that are viewed by local users.

According to one embodiment of the present invention, a page-based model may be used to manage content with any location-based system. A page may be for example, a display item that includes information relating to particular venue. The page may include text, photo, or other information. To facilitate managers creating, editing, and managing venues, pages and their associated messages, one or management interfaces and constructs may be provided to permit different types of users to manage content within a location-based system.

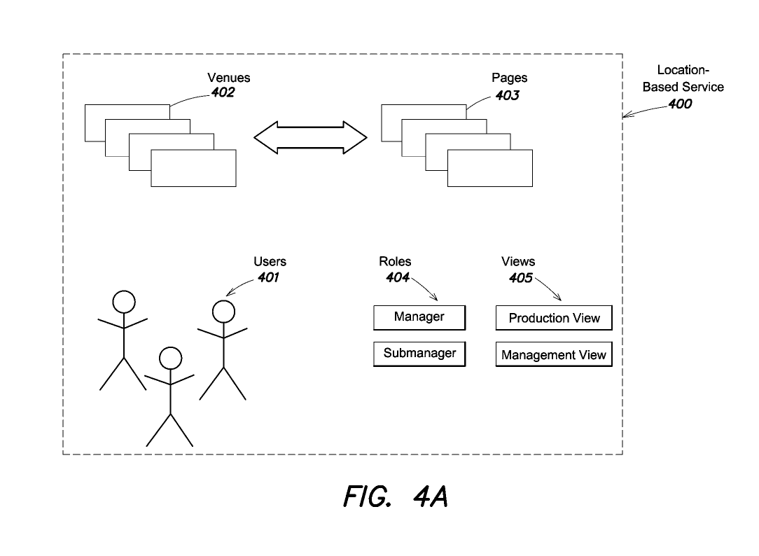

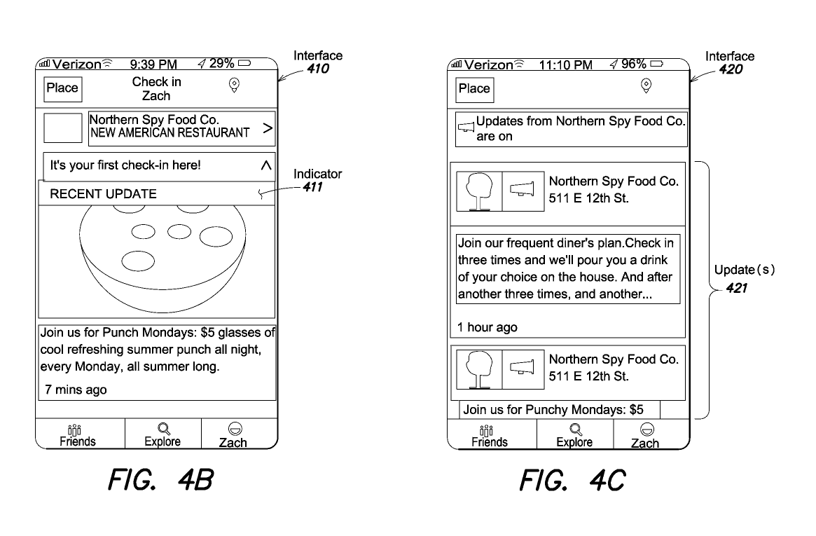

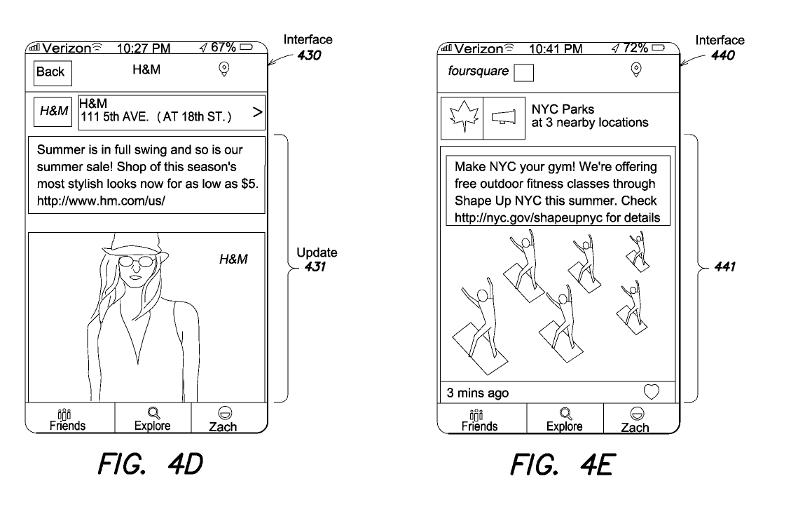

For example, as shown in more detail in FIG. 4A, a location-based service 400 may include one or more venues 402. Each venue may include an associated page (e.g., one or more of pages 403). One or more users (e.g. users 401) manage one or more pages (e.g. pages 403). Users 401 modify venues, pages, and other items using one or more roles in relation to the current venue or page. For instance, a plurality of roles 404 may be defined that allow user to perform as a manager, submanager, or other role in relation to those pages or venues. Furthermore, a number of views 405 may be created that allow a user to switch back and forth within the interface from a “live” or production version of what users experience within the location-based application and a management version of the interface.

FIGS. 4B-4E show example interfaces associated with messages that may be communicated in a location-based service according to one embodiment of the present invention. For instance, a location-based service may provide the capability for users such as managers, submanagers, or other user types to communicate with location-based service users. For instance, businesses may be able to communicate messages to their customers, such as updates, events, news, new specials the business is offering or other information. According to one embodiment, when users interact in a predefined manner with the location-based network, their location-based service application displays the appropriate message. Such information, when triggered within a location-based service may also be sent to other social networks such as Facebook, Twitter or other services or networks.

FIG. 4B shows an example interface 410 in accordance with one embodiment of the present invention. In particular, interface 410 may show, for a particular venue for the current user, one or more indicators 411 of messages associated with the particular venue. Indicator 411 may include, for example, pictures, text, or other information (e.g., location-based service items such as previously-created specials). As shown, the displayed message or update may be for a single venue.

FIG. 4C shows another example interface 420 in accordance with one embodiment of the present invention. In particular, interface 420 shows a series of updates 421 associated with a single venue. These updates may be shown as a series of time-based postings within a page associated with a particular venue. These updates may be periodically posted by a manager, submanager, etc. and displayed with a location-based service application interface.

FIG. 4D shows another example interface 430 in accordance with one embodiment of the present invention. In particular, interface 430 shows another example where messages are sent in association with multiple related venues such as chains of stores. For a particular venue (e.g., a local H&M store located at 111 5^{th} Avenue), the location-based service may display only the messages that relate to that particular venue (e.g., within an update window 431). Further, management tools may be provided for managers and submanagers to target specific messages to particular venue locations. Permission rules may be provided that allow certain user types access to create, modify and manage venues, pages, and their associated messages within the location-based service.

FIG. 4E shows another example interface 440 in accordance with one embodiment of the present invention. In particular, interface 440 shows another message example 441 where the message applies to multiple locations (e.g., NYC Parks at three (3) nearby locations). Thus, the location-based service may support the creation and targeting of messages for multiple venue locations. The location-based service may permit certain manager access to create messages only for certain venues of a chain, to allow such managers to develop their own local presence and personality with particular venues within the location-based service, while still keeping branding consistent with the parent chain.

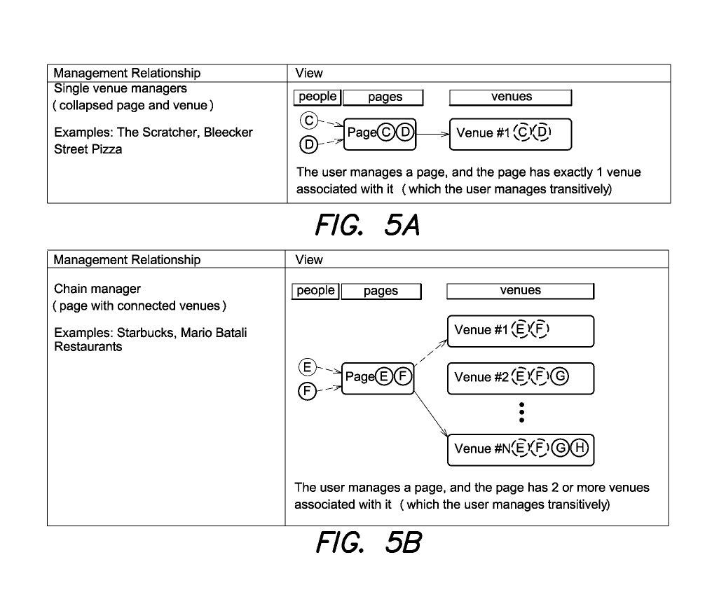

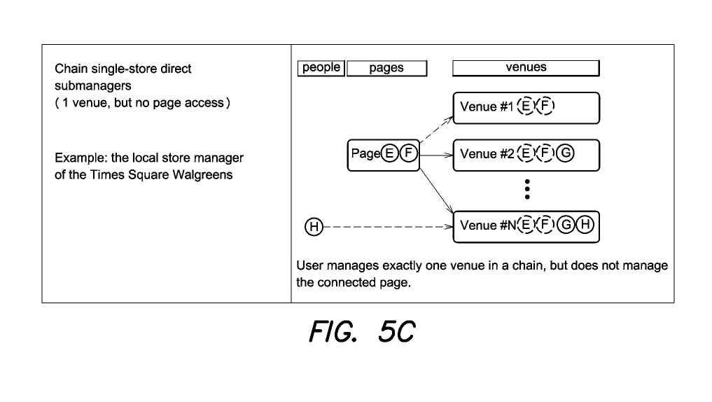

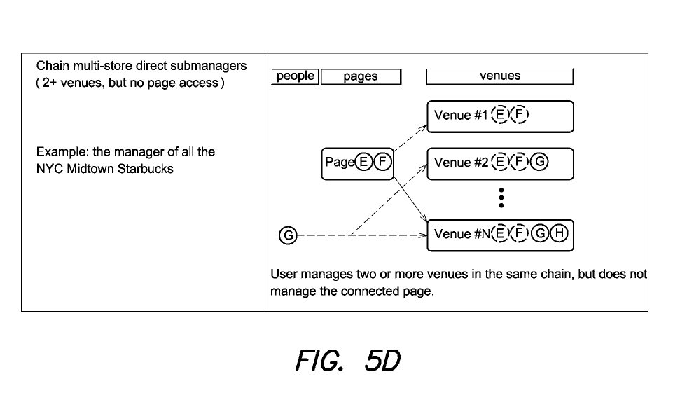

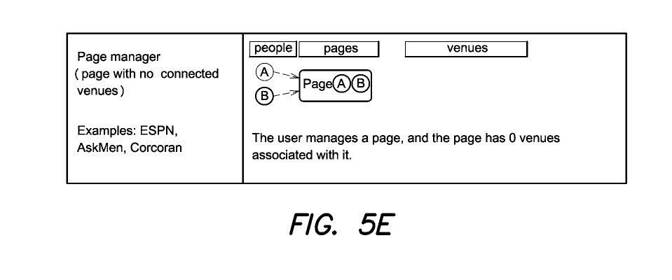

As discussed, the location-based service may include a number of permission relationships that permit managers to create, modify and manage pages, venues, and their associated messages. FIG. 5A shows one management relationship of pages according to one embodiment of the present invention. In particular, single venue managers of a collapsed page and venue show one basic construct that may be used within a location-based application. As shown, a user manages a page, and that page has exactly one venue associated with it which the user manages. One example implementation includes a local pizza shop managed by one or more employees.

FIG. 5B shows another management relationship according to another embodiment of the present invention. In particular, a chain manager is shown with multiple connected venues. In this scenario, a user manages a page, and the page has two or more venues associated with it which the user manages. One example implementation includes a chain of stores (e.g., Starbucks) managed by a managing user. In such a situation, the manager has the capability of managing the page and each connected venue.

FIG. 5C shows another management relationship according to another embodiment of the present invention. In particular, a chain single-store direct submanager is shown where the submanager manages the venue, but does not have access to manage the page. In the example shown, a user manages exactly one venue in the chain, but does not manage the connected page. An example of this may include a local store manager of the Times Square Walgreens, but that local store manager does not manage the main Walgreens page.

FIG. 5D shows another management relationship according to another embodiment of the present invention. In particular, a chain multi-store direct submanager is shown that manages two or more venues, but the chain multi-store direct submanager has no page access. For instance, as shown, the submanager manages two or more venues in the same chain, but the submanager does not manage the connected page. One example of this may include a manager of all the New York City midtown Starbucks locations, but that manager does not have page access to the main Starbucks page.

FIG. 5E shows another management relationship according to another embodiment of the present invention. In particular, a page manager manages a page where there are no connected venues to the page. As shown, one or more users manage a page, but that page has zero venues associated with it. One example of this may include the company ESPN, where there may be no venues but there may be a landing page for the purposes of displaying information to users of the location-based system.

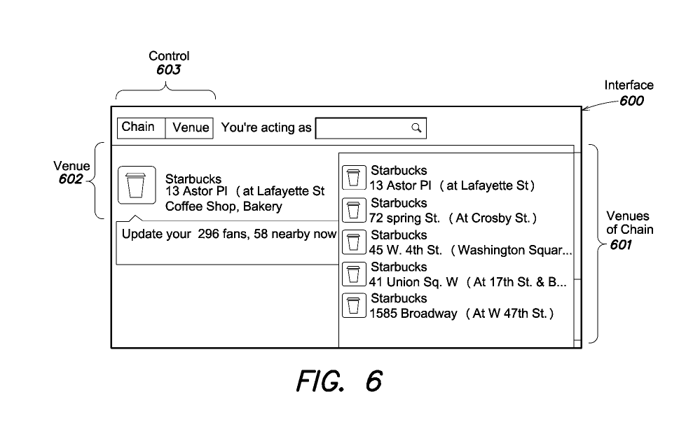

FIG. 6 shows one example interface for managing venues and pages according to one embodiment of the present invention. According to one embodiment, an interface 600 may be provided that shows all of the venues related to a particular chain. For instance, based on the user's profile and permissions, that user may be permitted to view and/or modify information relating to the chain and its defined venues. For instance, as shown in FIG. 6, a user may be permitted to view a number of venues 601 associated with the Starbucks chain of stores. A user may select one or more venues within a venue view to create individualized messages for one or more venues that can be selected within the interface. For instance, the manager/user may select a venue (e.g., venue 602) for the purposes of sending messages, modifying venue information, or other management functions. In one example, the manager/user may create a message for that particular venue. Interface 600 may include a control (e.g., control 603) that allows the manager to optionally go to a chain mode where all stores of the chain may be operated on or communicated with as a single entity.

The management interface may also include one or more controls that allow the user/manager to switch between a production version of the page in a management version of that page. Such controls may be displayed to the user if for example, the user has rights to manage particular venue (e.g., because the user is a manager of the page that has management rights over the venue).

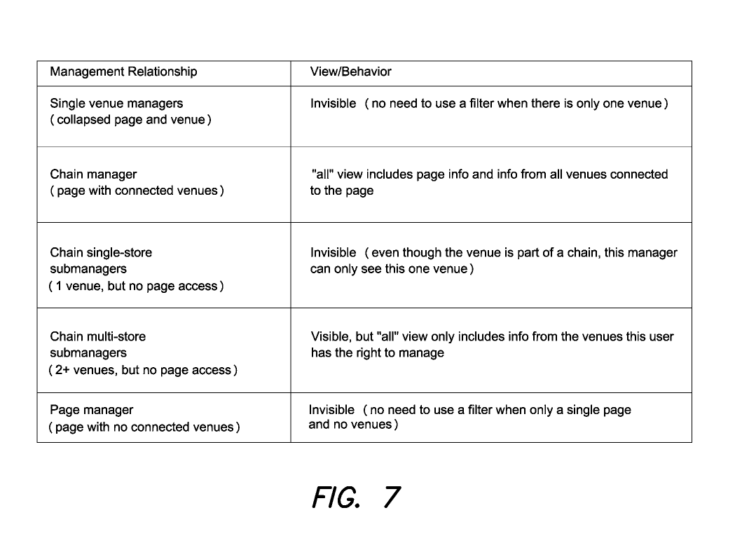

FIG. 7 shows a table of example management relationships associated with particular views and behaviors of the interface of the location-based application. For instance, for a single venue, a page in the venue may be in a collapsed mode where the page and the venue are displayed within one display. In cases where there is more than one venue, a filter may be used that limits the display to venues that the user can manage. However, when only one venue is managed, a filter may not be needed.

When a chain manager accesses a page with multiple connected venues, the page may be shown with an “all” view that includes the page info and info from all the venues that are connected to the page. In another example where chain single-store submanagers having one venue but no page access, the page may be made invisible and even though the venue is part of a chain, this manager can only see one venue and cannot modify the page.

For a chain multi-store sub manager that manages two or more venues but does not have page access, the page may be visible but the “all” view includes information from the venues that this particular user has the rights to manage. For a page manager with no connected venues, the venue list may be made invisible (e.g., by the location-based service within the user's display).

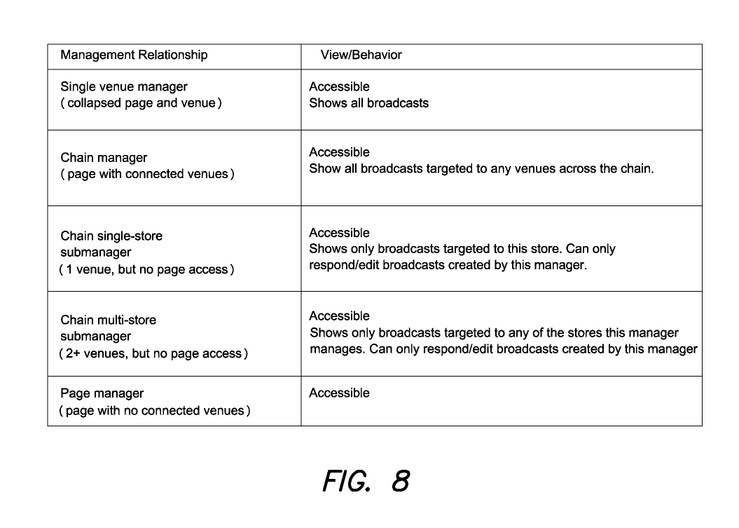

FIG. 8 shows a table of example relationships associated with particular views and behaviors of the interface of the location-based application in relation to messages within the location-based service. For single venue manager that manages a collapsed page of a venue, the manager may be able to see (e.g., within the interface of a location-based service application) all messages that have been defined for this particular venue (termed hereinafter as a “broadcast”). With a chain manager that has a page with connected venues, the chain manager may be able to see all broadcasts targeted to any venues across the chain. In a model where there is a chain single-store submanager having one venue, but no page access, the chain single-store submanager may only be able to see broadcasts that are targeted to the store. In this case, the manager can only respond or edit broadcasts created by the particular manager. In the case where there is a chain of multi-store submanagers having two or more venues but no page access, the chain multi-store submanager may be permitted to see broadcasts targeted to any of the store that this manager manages, and the manager can only respond or edit broadcasts created by this manager. For a page manager that manages a page with no connected venues, the page manager may be able to see all messages associated with the page.

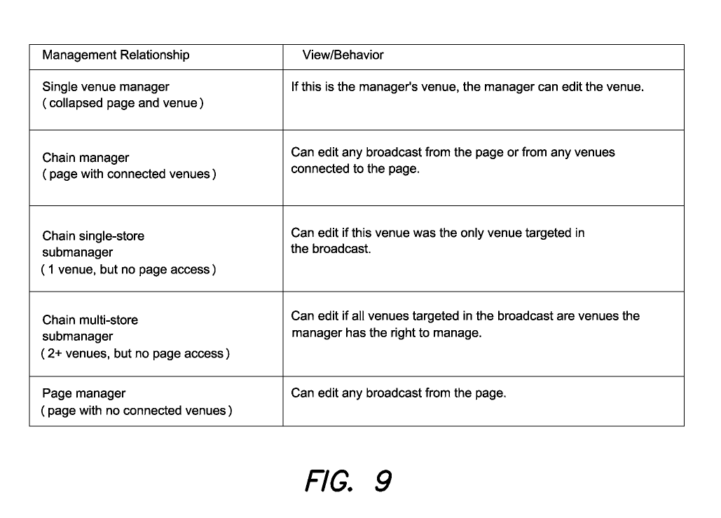

FIG. 9 shows a table of example management relationships associated with particular views and behaviors of the interface of the location-based application in relation to the editing of messages for particular venues. For example, for a single venue manager having collapsed page in venue, the manager may be permitted to edit the venue and any broadcast related to it. For a chain manager that manages a page with connected venues, the manager may be permitted to edit any broadcast message from the page or any venues that are connected to the page. For a chain single-store sub manager that manages one venue but has no page access, the manager can edit the broadcast message if this venue was the only thing you targeted in the broadcast. With a chain multi-store sub manager that manages two or more venues, the manager may edit all venues targeted in the broadcast if the venues are ones that the manager has rights to manage. For a page manager that manages a page with no connected venues, the page manager can edit any broadcasts from the page.

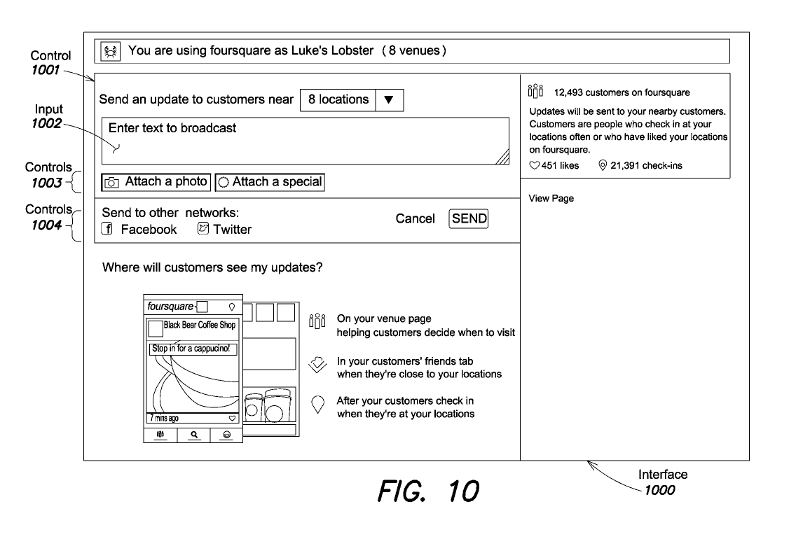

FIG. 10 shows an example management interface used to create a message according to one embodiment of the present invention. For instance, according to one embodiment, an interface 1000 may be provided that allows the user to create a message for one or more venues. Interface 1000 may show the user an indication that the particular message being created is being directed to more than one venue (e.g., a contextual indicator may indicate that the user is in a mode where he/she is creating a multi-venue message). A control (e.g., control 1001) may be provided that allows the user to control the venue(s) to which this broadcast may be directed. As discussed, such messages may be sent to users when they are near or within a predefined distance from the venue or are within a particular area.

Interface 1000 may also include controls that allow the user to create and/or attach content to the message, such as, for example, entering text within an input window (e.g., via input 1002), or attaching a photo or special (e.g., via one or more controls 1003). In one example, when selecting a photo attachment control, a photo upload dialog may be shown that allows the user to pick a particular photo to be displayed within the message. In another example, when a user selects an “attach a special” control, a dialog may be shown that allows the user to select a created special that may be defined for that particular venue or chain. Further, there may be other selectable options for the message, including sending the message to other networks (e.g., to a social network such as Twitter or Facebook). In one implementation, the defined message may be delivered when the appropriate action is performed by the user within the location-based service.

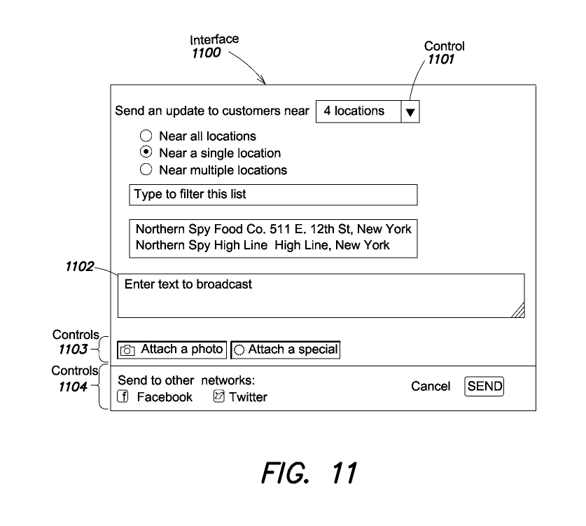

FIG. 11 shows another example interface that shows one example management interface used to create a message. For instance, an interface 1100 may be provided similar in function to interface 1000 that allows a user to create a message for one or more venues. The interface may include a control 1101 that allows the user to select one or more venues with which this message will be associated. Further, the interface may include a number of controls that permit the user to send the message when the user is located near all locations (e.g., the four (4) locations relating to a chain of venues), near a single location (e.g., one selected within an entry box or menu), or multiple locations. Similar to interface 1000, interface 1100 may include one or more controls that permit the user to enter text (e.g., via control 1102), photo(s) or special(s) (e.g., via control 1103), or control how or to what networks the message may be delivered (e.g., via controls 1104). By having a capability for a user to operate at different level of a chain of venues allows chain and regional managers to send messages from all locations in their chain, while still allowing individual store managers to develop unique identity and rapport with their own local clients.

Other interfaces may be provided for managing communications with users of a location-based service. For instance, a broadcast detail page may be provided that allows a manager to edit one or more broadcast messages. According to one aspect, the manager may be permitted to edit a broadcast message until a certain amount of activities with respect to the broadcast message occur, such as for example, reviews of the message, shares, or other actions. In one embodiment, the interface permits the manager to comment on the broadcast message, respond to, curate, or delete user comments once public commenting launches. In another embodiment, statistics may be shown to the manager including the number of accesses to the message (e.g., over time), number of messages delivered, or other criteria associated with the message. Other interfaces may be provided that customize what activities the user can perform to receive messages (e.g., the user checked in three times at this location), what time(s) of day the messages should be sent (e.g., a breakfast ad from Starbucks should be sent from 6 AM-11 AM), or other criteria necessary to trigger the display of a particular message.

### Example Computer Implementations

Processes described above are merely illustrative embodiments of systems that may provide messaging capabilities in association with a location-based service. Such illustrative embodiments are not intended to limit the scope of the present invention, as any of numerous other implementations for performing the invention. None of the claims set forth below are intended to be limited to any particular implementation of a method of providing player incentives, unless such claim includes a limitation explicitly reciting a particular implementation.

Processes and methods associated with various embodiments, acts thereof and various embodiments and variations of these methods and acts, individually or in combination, may be defined by computer-readable signals tangibly embodied on a computer-readable medium, for example, a non-volatile recording medium, an integrated circuit memory element, or a combination thereof. According to one embodiment, the computer-readable medium may be non-transitory in that the computer-executable instructions may be stored permanently or semi-permanently on the medium. Such signals may define instructions, for example, as part of one or more programs, that, as a result of being executed by a computer, instruct the computer to perform one or more of the methods or acts described herein, and/or various embodiments, variations and combinations thereof. Such instructions may be written in any of a plurality of programming languages, for example, Java, Visual Basic, C, C#, or C++, Fortran, Pascal, Eiffel, Basic, COBOL, etc., or any of a variety of combinations thereof. The computer-readable medium on which such instructions are stored may reside on one or more of the components of a general-purpose computer described above, and may be distributed across one or more of such components.

The computer-readable medium may be transportable such that the instructions stored thereon can be loaded onto any computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, ARM Cortex processor, Qualcomm Scorpion processor, or any other type of processor. It should be appreciated that one or more of any type computer system may be used to partially or fully automate play of the described game according to various embodiments of the invention. Further, the software design system may be located on a single computer or may be distributed among a plurality of computers attached by a communications network.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the present invention.

One or more portions of the computer system may be distributed across one or more computer systems coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C#(C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

Further, on each of the one or more computer systems that include one or more components of distributed system 200, each of the components may reside in one or more locations on the system. For example, different portions of the components of system 200 may reside in different areas of memory (e.g., RAM, ROM, disk, etc.) on one or more computer systems. Each of such one or more computer systems may include, among other components, a plurality of known components such as one or more processors, a memory system, a disk storage system, one or more network interfaces, and one or more busses or other internal communication links interconnecting the various components.

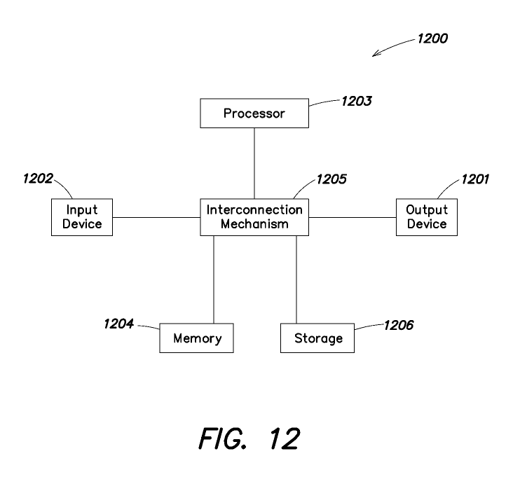

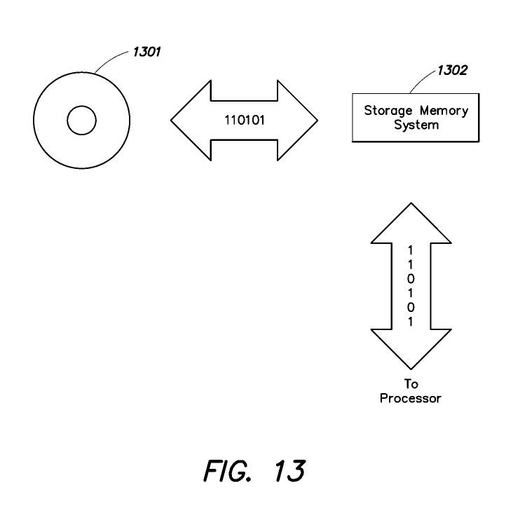

Any number of systems of distributed system 200 may be implemented on a computer system described below in relation to FIGS. 12 and 13. In particular, FIG. 12 shows an example computer system 1200 used to implement various aspects. FIG. 13 shows an example storage system that may be used.

System 1200 is merely an illustrative embodiment of a computer system suitable for implementing various aspects of the invention. Such an illustrative embodiment is not intended to limit the scope of the invention, as any of numerous other implementations of the system, for example, are possible and are intended to fall within the scope of the invention. For example, a virtual computing platform may be used. None of the claims set forth below are intended to be limited to any particular implementation of the system unless such claim includes a limitation explicitly reciting a particular implementation.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate integration of the location-based services with the other systems and services according to various embodiments of the invention. Further, the software design system may be located on a single computer or may be distributed among a plurality of computers attached by a communications network.

For example, various aspects of the invention may be implemented as specialized software executing in a general-purpose computer system 1200 such as that shown in FIG. 12. The computer system 1200 may include a processor 1203 connected to one or more memory devices 1204, such as a disk drive, memory, or other device for storing data. Memory 1204 is typically used for storing programs and data during operation of the computer system 1200. Components of computer system 1200 may be coupled by an interconnection mechanism 1205, which may include one or more busses (e.g., between components that are integrated within a same machine) and/or a network (e.g., between components that reside on separate discrete machines). The interconnection mechanism 1205 enables communications (e.g., data, instructions) to be exchanged between system components of system 1200. Computer system 1200 also includes one or more input devices 1202, for example, a keyboard, mouse, trackball, microphone, touch screen, and one or more output devices 1201, for example, a printing device, display screen, and/or speaker. In addition, computer system 1200 may contain one or more interfaces (not shown) that connect computer system 1200 to a communication network (in addition or as an alternative to the interconnection mechanism 1205.

The storage system 1206, shown in greater detail in FIG. 13, typically includes a computer readable and writeable nonvolatile recording medium 1301 in which signals are stored that define a program to be executed by the processor or information stored on or in the medium 1301 to be processed by the program. The medium may, for example, be a disk or flash memory. Typically, in operation, the processor causes data to be read from the nonvolatile recording medium 1301 into another memory 1302 that allows for faster access to the information by the processor than does the medium 1301. This memory 1302 is typically a volatile, random access memory such as a dynamic random access memory (DRAM) or static memory (SRAM). It may be located in storage system 1206, as shown, or in memory system 1204, not shown. The processor 1203 generally manipulates the data within the integrated circuit memory 1204, 1302 and then copies the data to the medium 1301 after processing is completed. A variety of mechanisms are known for managing data movement between the medium 1301 and the integrated circuit memory element 1204, 1302, and the invention is not limited thereto. The invention is not limited to a particular memory system 1204 or storage system 1206.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 1200 is shown by way of example as one type of computer system upon which various aspects of the invention may be practiced, it should be appreciated that aspects of the invention are not limited to being implemented on the computer system as shown in FIG. 12. Various aspects of the invention may be practiced on one or more computers having a different architecture or components that that shown in FIG. 12.

Computer system 1200 may be a general-purpose computer system that is programmable using a high-level computer programming language. Computer system 1200 may be also implemented using specially programmed, special purpose hardware. In computer system 1200, processor 1203 is typically a commercially available processor such as the well-known Pentium, Pentium, Core, Core Vpro, Xeon, or Itanium class processors available from the Intel Corporation. Many other processors are available. Such a processor usually executes an operating system which may be, for example, the Windows NT, Windows 2000 (Windows ME), Windows XP, Windows Vista or Windows 7 or 8 operating systems available from the Microsoft Corporation, MAC OS X Snow Leopard, MAC OS X Lion operating systems available from Apple Computer, the Solaris Operating System available from Sun Microsystems, iOS Blackberry OS, Windows 7 Mobile or Android OS operating system or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, or C#(C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented using various Internet technologies and other programming methods. Further, various aspects of the present invention may be implemented in a cloud-based computing platform, such as the well-known EC2 platform available commercially from Amazon.com, Seattle, Wash., among others. Various aspects of the invention may be implemented as programmed or non-programmed elements, or any combination thereof.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for presenting information to a user by a location-based system, the method comprising acts of:
creating, by a merchant associated with a venue, a message to be communicated to one or more users in the location-based system;
storing the message in the location-based system;
determining user activity associated with a user in the location-based system;
determining, based on the user activity in the location-based system, whether the message should be communicated to the user; and
if so, communicating the message to the user.

2. The method according to claim 1, wherein the user activity includes at least one of a group of user activities comprising:
a check-in to the venue;
a “like” of the venue;
travel by the user to a location within a distance or area of the venue; and
an action performed by the user in a location-based system.

3. The method according to claim 1, wherein the act of determining whether the message should be communicated to the user further comprises an act of determining if the user provided an indication that the user would like to receive messages from the venue.

4. The method according to claim 1, wherein the act of determining whether the message should be communicated to the user further comprises an act of determining whether the user has checked into the venue a predetermined number of times.

5. The method according to claim 1, wherein the act of determining whether the message should be communicated to the user further comprises an act of determining whether the user has achieved a defined level of activity with the venue.

6. The method according to claim 1, wherein the act of determining whether the message should be communicated to the user further comprises an act of determining whether the user has performed a group of sufficient activities within the location-based network.

7. The method according to claim 1, further comprising an act of providing for a merchant to delegate management and creation of message functions to one or more entities.

8. The method according to claim 7, wherein the merchant is permitted to delegate management and creation of messages based on a location of a venue.

9. The method according to claim 1, wherein the merchant is permitted to specify a time of delivery in association with communicating the message to the user.

10. The method according to claim 1, further comprising acts of determining a location of the user, and determining, at least in part based on the determined location of the user, whether the message should be communicated to the user.

11. The method according to claim 10, further comprising acts of determining a predefined location in which the message should be delivered, and determining whether the user is located within the predefined location.

12. The method according to claim 11, wherein the act of determining a predefined location includes an act of predefining, by the merchant, an area in which the message should be delivered, and the method further comprises an act of determining whether the user is located within the predefined area.

13. The method according to claim 10, further comprising acts of determining a predefined location in which the message should be delivered, and determining whether the user is located near the predefined location.

14. The method according to claim 12, wherein the act of predefining an area in which the message should be delivered includes at least one of a group comprising:
defining a locale;
defining a location and radius around the location;
defining latitude and longitudinal limits; and
defining a geographical area.

15. The method according to claim 7, further comprising an act of permitting a submanager to define and send one or more messages associated with a venue of a chain that the submanager is permitted to manage.

16. The method according to claim 7, further comprising an act of permitting a manager to selectively create and send messages to one or more venues of a chain of venues.

17. The method according to claim 7, further comprising an act of restricting access to a submanager to perform management functions to one or more venues of a chain that the submanager is permitted to manage.

18. A method for processing venue information in a location-based system, the method comprising acts of:
receiving a message to be communicated to one or more users in the location-based system;
storing the message in the location-based system;
determining user activity in the location-based system;
determining, based on the user activity in the location-based system, whether the message should be communicated to the user; and
if so, communicating the message to the user.

19. The method according to claim 18, further comprising acts of determining a location of the user, and determining, at least in part based on the determined location of the user, whether the message should be communicated to the user.

20. A location-based system for presenting information to a user, the system comprising:
a component that permits creation, by a merchant associated with a venue, a message to be communicated to one or more users in the location-based system;
a memory adapted to store the created message;
a component adapted to determine user activity associated with a user in the location-based system;
a component adapted to determine, based on the user activity in the location-based system, whether the message should be communicated to the user; and
a component adapted to communicate the message to the user, if it is determined by the component that is adapted to determine, based on the user activity in the location-based system, whether the message should be communicated to the user that the message should be communicated.

21. The system according to claim 20, wherein the user activity includes at least one of a group of user activities comprising:
a check-in to the venue;
a “like” of the venue;
travel by the user to a location within a distance or area of the venue; and
an action performed by the user in a location-based system.

22. The system according to claim 20, further comprising a component adapted to determine if the user provided an indication that the user would like to receive messages from the venue.

23. The system according to claim 20, wherein the component adapted to determine, based on the user activity in the location-based system, whether the message should be communicated to the user is responsive to a component that determines whether the user has checked into the venue a predetermined number of times.

24. The system according to claim 20, wherein the component adapted to determine, based on the user activity in the location-based system, whether the message should be communicated to the user is responsive to a component that a component that determines whether the user has achieved a defined level of activity with the venue.

25. The system according to claim 20, wherein the component adapted to determine, based on the user activity in the location-based system, whether the message should be communicated to the user is responsive to a component that determines whether the user has performed a group of sufficient activities within the location-based network.

26. The system according to claim 20, further comprising an interface that permits merchant to delegate management and creation of message functions to one or more entities.

27. The system according to claim 26, wherein the interface permits the merchant to delegate management and creation of messages based on a location of a venue.

28. The system according to claim 20, further comprising an interface that permits the merchant to specify a time of delivery in association with communicating the message to the user.

29. The system according to claim 20, further comprising a component adapted to determine a location of the user, and a component adapted to determine, at least in part based on the determined location of the user, whether the message should be communicated to the user.

30. The system according to claim 29, further comprising a component adapted to determine a predefined location in which the message should be delivered, and a component that is adapted to determine whether the user is located within the predefined location.

31. The system according to claim 30, wherein the component adapted to determine a predefined location includes a component that accepts information from the merchant that defines an area in which the message should be delivered, and wherein the system further comprises a component adapted to determine whether the user is located within the predefined area.

32. The system according to claim 29, further comprising a component adapted to determine a predefined location in which the message should be delivered, and a component adapted to determine whether the user is located near the predefined location.

33. The system according to claim 31, wherein the information received from the merchant that defines an area in which the message should be delivered includes at least one of a group comprising:
a locale;
a location and radius around the location;
latitude and longitudinal limits; and
a geographical area.

34. The system according to claim 26, further comprising an interface that permits a submanager to define and send one or more messages associated with a venue of a chain that the submanager is permitted to manage.

35. The system according to claim 26, further comprising an interface that permits a manager to selectively create and send messages to one or more venues of a chain of venues.

36. The system according to claim 26, further comprising an interface that restricts access to a submanager to perform management functions to one or more venues of a chain that the submanager is permitted to manage.
